(19) United States
(12) Patent Application Publication
(10) Pub. No.: US 2009/0044448 A1
(43) Pub. Date: Feb. 19, 2009

(54) Door

(76) Inventor: Michael Hoermann, Halle/Westphalia (DE)

Correspondence Address: DILWORTH & BARRESE, LLP, 333 EARLE OVINGTON BLVD., SUITE 702, UNIONDALE, NY, 11553, US

(21) Appl. No.: 12/215,962

(22) Filed: Jul. 1, 2008

(30) Foreign Application Priority Data
Jul. 2, 2007 (DE) UM 202007009285.7
Jul. 9, 2007 (DE) UM 202007009576.7

(51) Int. Cl. E05F 15/02

(52) U.S. Cl. 49/28

(57) ABSTRACT

The present invention relates to a door having a door leaf which has a closing edge and which can be moved within a travel path by means of a drive, having a connection for an external light barrier which can be arranged in the travel path of the door to detect any objects or body parts present there and having a control for the reversal of the door movement when preset shut-off forces are reached, wherein a first set of shut-off forces is associated with the control when a light barrier is connected and activated; and wherein a second set of shut-off forces is associated with the control when the light barrier is deactivated

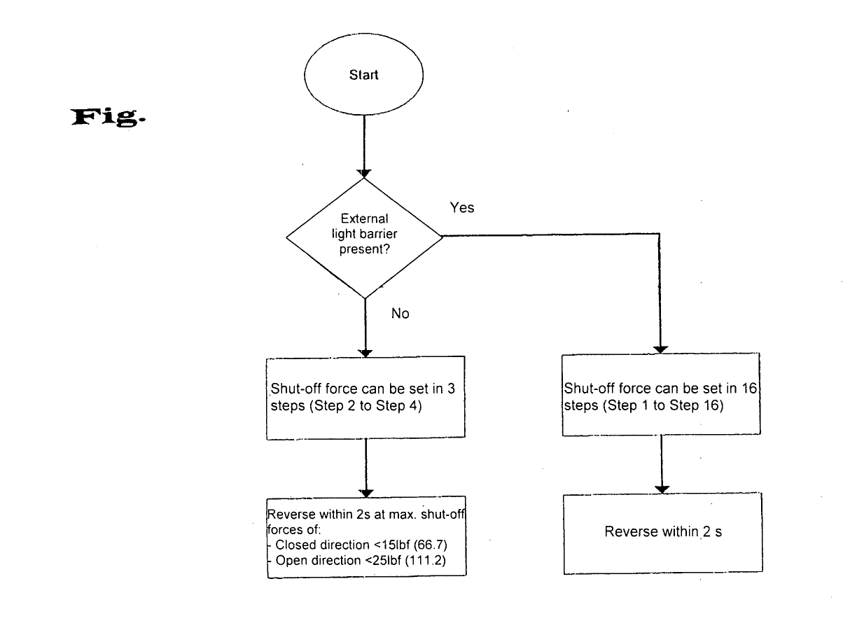

The invention relates to a door having a door leaf which has a closing edge and which can be moved within a travel path by means of a drive, having a connection for an external light barrier which can be arranged in the travel path of the door to detect any objects or body parts present there and having a control for the reversal of the door movement when preset shut-off forces are reached.

Light barriers are frequently used in such doors which serve as protection against jamming, i.e. as a security against a jamming of objects or body parts on the closing procedure of the door. On an interruption of the light beam of the light barrier, a control signal is thus generated which brakes the drive and reverses it in the opposite direction under certain circumstances.

A quick-moving door is, for example, known from EP 0 284 066 B1 which is provided with a switching device which comprises a light barrier and which is used as jamming protection. In this connection, the light barrier having a transmitter and a receiver is arranged at a specific distance beneath a closing section of the door leaf, with this distance corresponding to the braking path. The braking path is also called the stop delay and consists of the switching delay and the braking path.

It is, however, also known to arrange one or more light barriers at a fixed position of the travel path of the door leaf. The present invention relates to any arrangement of a light barrier for the monitoring of any obstacles in the travel path of the door.

In addition to a monitoring of the travel path of the door for possible obstacles by a light barrier, it is also already known to measure any forces which may occur at the closing edge. If a force is measured here which exceeds a preset value, it is recognized as a shut-off force by a control arranged in the door drive. On recognition of the shut-off force, the door is stopped and reversed.

In accordance with an American standard, the control for a door where no light barrier is provided must already reverse the door after a preset time duration on reaching very small shut-off forces.

It is the object of the present invention to provide a multifunctional door having a corresponding door drive whose function can be easily switched over to an operational setting including a light barrier and to an operational setting without a light barrier.

This object is solved in accordance with the invention by the combination of the features of claim 1.

Accordingly, a door is provided having a door leaf which has a closing edge and which is movable within a travel path by means of a drive. This door has a connection for an external light barrier which can be arranged in the travel path of the door to detect any objects or body parts present there. Furthermore, a control is provided to reverse the door movement when preset shut-off forces are reached. With a closed and activated light barrier, in accordance with the invention, a first set of shut-off forces is associated with the control, whereas a second set of shut-off forces is associated with the control with a deactivated light barrier. In accordance with the invention, depending on the state of the door, i.e. depending on whether it is moved while being monitored by a light barrier or without this monitoring, a more or less sensitive shut-off force value can thus be set. Such a door can be put into operation during installation in a very simple and safe manner. It is therefore reliably prevented here that an incorrect value for a shut-off force is programmed.

Advantageous aspects of the invention result from the dependent claims following on from the main claim.

Accordingly, the first set of shut-off forces relates to higher shut-off forces than the second set.

The first set and the second set of shut-off forces furthermore each have a plurality of values which can be set in dependence on the desired shut-off sensitivity of the door.

The first set and the second set of shut-off forces can each be a part range of a total selection range which is adjustable step-wise and in which the first values include a part range which comprises lower shut-off forces and the second values comprise a second part range comprising comparatively larger shut-off forces.

In accordance with a preferred embodiment of the invention, the selection range can be set in 16 steps. A sensitive setting of the shut-off forces is herewith possible.

In this connection, the second set of shut-off forces can comprise the steps 1 to 4 and the first set of shut-off forces can comprise the steps 5 to 16.

The shut-off force on the closing of the door can amount to approximately 400 to 700 N with an activated light barrier. Since the presence of an object or of a person is here monitored via the travel path of the door by a light barrier, a comparatively higher shut-off force can be set here. With a deactivated light barrier, the shut-off force on the closing of the door advantageously amounts, in contrast, to only 66.7 N. Since here therefore no monitoring by a light barrier takes place, the shut-off force is set much lower in order to reliably prevent the jamming of an object and in particular an injury to a person.

The shut-off force on the opening of the door with a deactivated light barrier can, in contrast, be set somewhat higher. The corresponding value here can advantageously amount to 111.2 N. The American “UL Requirements 325” can be observed by observing the aforesaid values.

In accordance with a preferred embodiment of the invention, the control can be configured such that the door is reversed after a specific time duration on reaching the shut-off force. This time duration can advantageously amount to a maximum of 2 seconds. The state of the light barrier can be able to be input via a programming menu in accordance with an alternative of the invention. It is therefore possible to input here whether a corresponding light barrier is connected or not.

An alternative preferred embodiment of the invention consists of the fact that the state of the light barrier, that is the information whether a light barrier is active or does not cooperate with the control can be automatically recognized.

The invention furthermore relates to a drive comprising a control for a door in accordance with one of the claims 1 to 13.

Further features, details and advantages of the invention result from an embodiment shown with reference to the flowchart shown in the only Figure.

After the installation of a door, for example a garage door, whether an external light barrier is present or not is input on the programming of the control of the door drive after the program start. In an alternative embodiment variant, whether an external light barrier is present here is automatically recognized by the control of the garage door drive here.

If it is recognized, as was shown in the Figure as an alternative, that an external light barrier is present, the shut-off force is selected as desired in a step of a 16-step set of shut-off forces. In this connection, step 1 corresponds to the lowest shut-off force and step 16 corresponds to the comparatively highest shut-off force. The smaller the step number is, the more sensitive the shut-off monitoring of the door therefore is. If the limit shut-off force preset by means of the shut-off force setting is now reached during the operation of the door, the door movement is stopped and the door reverses after a time which can likewise be preset and which is set at 2 seconds in the embodiment.

If it is now recognized that no external light barrier is present, the selection range of the 16-step shut-off force setting is reduced to three steps. Only steps 2 to 4 can be selected by the installing engineer here, with the least sensitive step 4 being able to be set to a maximum force of 66.7 N on a closing movement of the door and to 111.2 N on an opening movement of the door. The respective shut-off force steps can therefore be able to be input differently in dependence on the direction of movement of the door. These maximum shut-off forces correspond to step 4. A lower shut-off force can still be selected by inputting the steps 3 and 2.

The door movement is also stopped after reaching the limit shut-off force and the door movement is reversed within 2 seconds in the present case in which no external light barrier is present.

Even when the least sensitive step 4 is set, it is ensured here that the American “UL Requirements 325” are observed.

1. A door having a door leaf which has a closing edge and which can be moved within a travel path by a drive, having a connection for an external light barrier which can be arranged in the travel path of the door to detect any objects or body parts present there and having a control for the reversal of the door movement when preset shut-off forces are reached, wherein
a first set of shut-off forces is associated with the control when a light barrier is connected and activated; and
a second set of shut-off forces is associated with the control when the light barrier is deactivated.

2. A door in accordance with claim 1, wherein the first set of shut-off forces has higher shut-off forces than the second set of shut-off forces.

3. A door in accordance with claim 2, wherein the first set and the second set of shut-off forces each comprise a plurality of values which can be set in accordance with the desired shut-off sensitivity of the door.

4. A door in accordance with claim 1, wherein the first set and the second set of shut-off forces are part ranges of a total selection range which can be set step-wise and in which the first values include a part range which comprises low shut-off forces and the second values include a second part range comprising comparatively larger shut-off forces.

5. A door in accordance with claim 4, wherein the selection range can be set in 16 steps.

6. A door in accordance with claim 5, wherein the second set of shut-off forces comprises the steps 1 to 4 and the first set of shut-off forces comprises the steps 5 to 16.

7. A door in accordance with claim 1, wherein the shut-off force amounts to approximately 400 N-700 N on the closing of the door with an activated light barrier.

8. A door in accordance with claim 1, wherein the shut-off force amounts to approximately 66.7 N on the closing of the door with a deactivated light barrier.

9. A door in accordance with claim 1, wherein the shut-off force amounts to 111.2 N on the opening of the door with a deactivated light barrier.

10. A door in accordance with claim 8, wherein the control is configured such that the door is reversed after a specific time duration on reaching the shut-off force.

11. A door in accordance with claim 10, wherein characterized in that the time duration amounts to at most 2 seconds.

12. A door in accordance with claim 1, wherein the state of the light barrier can be input via a programming menu.

13. A door in accordance with claim 1, wherein the state of the light barrier can be recognized automatically.

14. A drive comprising a control for a door in accordance with claim 1.

15. A door in accordance with claim 2, wherein the first set and the second set of shut-off forces are part ranges of a total selection range which can be set step-wise and in which the first values include a part range which comprises low shut-off forces and the second values include a second part range comprising comparatively larger shut-off forces.

16. A door in accordance with claim 3, wherein the first set and the second set of shut-off forces are part ranges of a total selection range which can be set step-wise and in which the first values include a part range which comprises low shut-off forces and the second values include a second part range comprising comparatively larger shut-off forces.

17. A door in accordance with claim 16, wherein the selection range can be set in 16 steps.

18. A door in accordance with claim 15, wherein the selection range can be set in 16 steps.

19. A door in accordance with claim 18, wherein the second set of shut-off forces comprises the steps 1 to 4 and the first set of shut-off forces comprises the steps 5 to 16.

20. A door in accordance with claim 17, wherein the second set of shut-off forces comprises the steps 1 to 4 and the first set of shut-off forces comprises the steps 5 to 16.
